(19) United States
(12) Patent Application Publication
(10) Pub. No.: US 2003/0018553 A1
(43) Pub. Date: Jan. 23, 2003

(54) System for automatically generating a list of merchants in conjunction with the generation of gift certificate

(75) Inventor: Wesley D. Lindquist, Kansas City, MO (US)

Correspondence Address: PATTON BOGGS, PO BOX 270930, LOUISVILLE, CO, 80027, US

(73) Assignee: Hallmark Cards, Incorporated

(21) Appl. No.: 09/911,339

(22) Filed: Jul. 23, 2001

(51) Int. Cl. G06F 7/00; G06F 17/30

(52) U.S. Cl. 705/35

(57) ABSTRACT

The automated gift certificate generation system enables the user to manually input data indicative of the gift certificate recipient, or simply download an entry from an address book, to the automated gift certificate generation system. The automated gift certificate generation system uses the gift certificate recipient data to identify merchants that are located in the vicinity of the gift certificate recipient. This process can optionally include using recipient profile data that identifies the interests and/or preferences of the gift certificate recipient. The automated gift certificate generation system automatically produces a list of available merchants that satisfy the selection parameters of the user, including proximity to the gift certificate recipient. The user can then select one or more of the merchants from this list and the automated gift certificate generation system produces a customized gift certificate addressed to the gift certificate recipient. In addition, the automated gift certificate generation system can also produce a map that provides the gift certificate recipient with directions to the merchant's store location from the gift certificate recipient's address.

### CROSS REFERENCE TO RELATED APPLICATIONS

This application is related to U.S. patent application Ser. No. 09/711,986, titled “System For Automatically Generating A Map In Conjunction With The Generation Of An Gift certificate.”

### FIELD OF THE INVENTION

This invention relates to the field of gift certificates and, in particular, to a system for automatically identifying merchants that are located in the vicinity of the gift certificate recipient, in conjunction with the generation of a gift certificate.

### Problem

It is a problem in the field of gift certificates that the purchase of a gift certificate is frequently inconvenient, since the user who purchases the gift certificate must travel to the merchant's store to obtain the gift certificate. The user must then personally deliver or mail the gift certificate to the gift certificate recipient. In addition, the gift certificate recipient may find it inconvenient to redeem the gift certificate, since the merchant who issued the gift certificate may not have a presence in a location that is convenient to the gift certificate recipient.

One attempt to solve these problems is the use of systems where the user can purchase a gift certificate by executing an electronic transaction over the Internet. In this case, the user eliminates the trip to the merchant's location, and may have the option of printing the gift certificate at home on their printer, having the merchant mail the gift certificate to the gift certificate recipient, or e-mail the gift certificate to the gift certificate recipient. These systems begin to address the above-noted problems but fail to address the issue of convenience of redemption of the gift certificate. The user in many cases is not be aware of whether the selected merchant has a store located in the vicinity of the gift certificate recipient and simply selects a merchant based on their determination of an appropriate merchant. This process relies on the user's ability to select a merchant that is both convenient to the gift certificate recipient and that is a purveyor of goods that are of interest to the gift certificate recipient.

There is presently no simple system that enables the individual who is purchasing a gift certificate to automatically identify merchants who are located in the vicinity of the gift certificate recipient, that carry products of interest to the gift certificate recipient and to also produce a map having directions to direct the gift certificate recipient to the merchant.

### Solution

The above-described problems are solved and a technical advance achieved by the present system for automatically generating a list of merchants in conjunction with the generation of a gift certificate (termed “automated gift certificate generation system” herein) which automatically generates a list of available merchants in conjunction with the generation of a gift certificate. This automated gift certificate generation system enables the user to manually input data indicative of the gift certificate recipient, or simply download an entry from an address book, to the automated gift certificate generation system. The automated gift certificate generation system uses the gift certificate recipient data to identify merchants that are located in the vicinity of the gift certificate recipient, such as within a predetermined radius of the recipient. This process can optionally include using recipient profile data that identifies the interests and/or preferences of the gift certificate recipient. The automated gift certificate generation system automatically produces a list of available merchants that satisfy the selection parameters of the user, including proximity to the gift certificate recipient. The user can then select one or more of the merchants from this list and the automated gift certificate generation system produces a customized gift certificate addressed to the gift certificate recipient. In addition, the automated gift certificate generation system can also produce a map that provides the gift certificate recipient with directions to the merchant's store location from the gift certificate recipient's address.

The automated gift certificate generation system can produce a paper gift certificate with the map printed thereon, or print the map as an enclosure, or print the map as a “tip-on” which is removably affixed to the gift certificate. Alternatively, the automated gift certificate generation system can produce an electronic gift certificate and associated map for transmission to the gift certificate recipient via a communication medium. The gift certificates themselves can be selected by the user from a collection of standard gift certificates and the user can customize the selected gift certificate as desired. The access to the gift certificate database can be via a communication medium and the gift certificates themselves can be printed locally by the user or can be printed at a fulfillment center and mailed to the gift certificate recipient.

### BRIEF DESCRIPTION OF THE DRAWING

FIGS. 1A and 1B illustrate in block diagram form the overall architecture of the present automated gift certificate generation system and a data communication environment in which it is operational;

FIGS. 2A & 2B illustrate in flow diagram form the operation of the present automated gift certificate generation system;

FIG. 3 illustrates the content of a typical option screen presented to the user in the operation of the present automated gift certificate generation system; and

FIG. 4 illustrates a typical map generated by the present automated gift certificate generation system with associated written directions.

### DETAILED DESCRIPTION

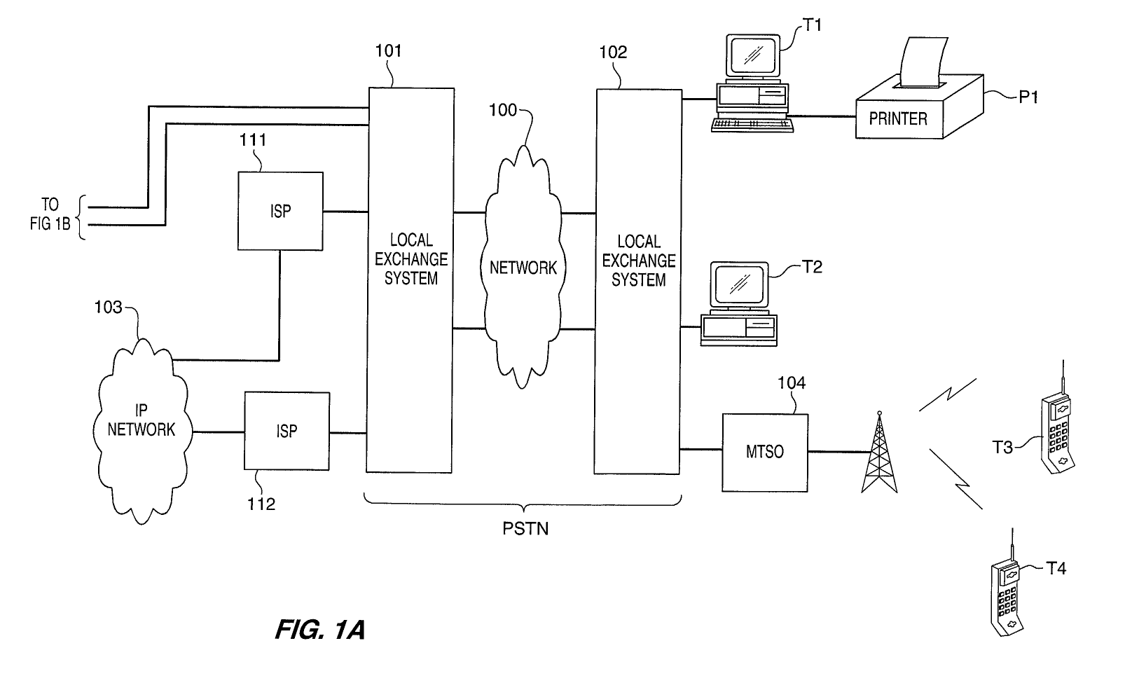

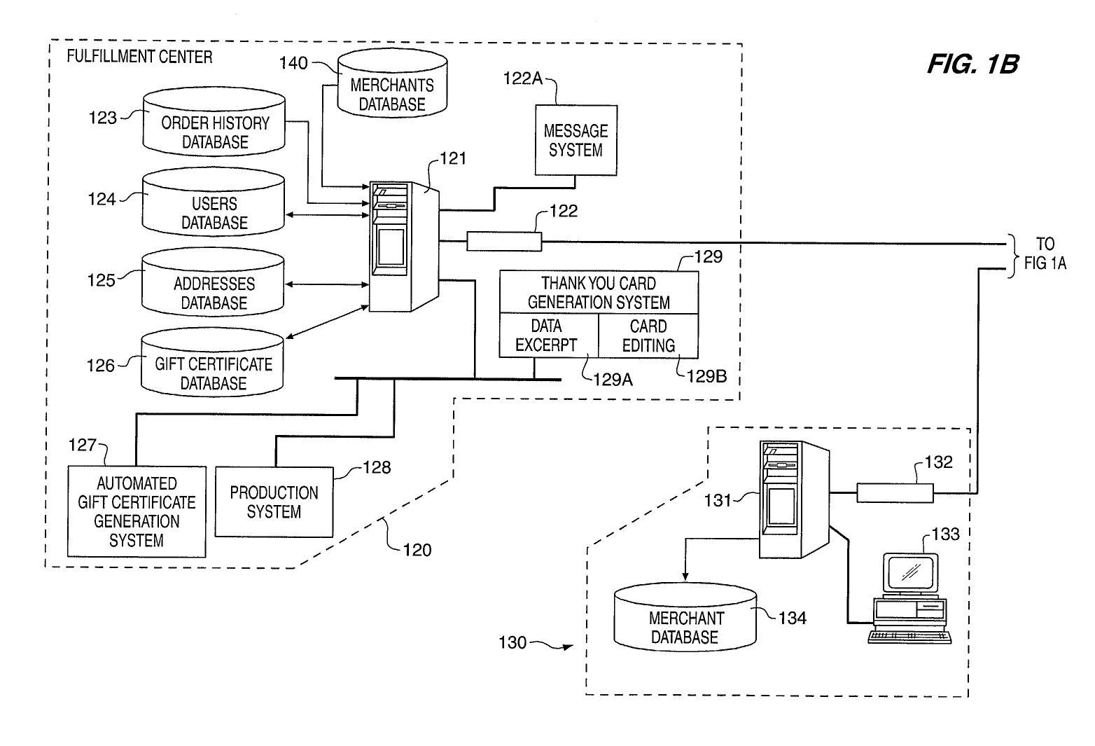

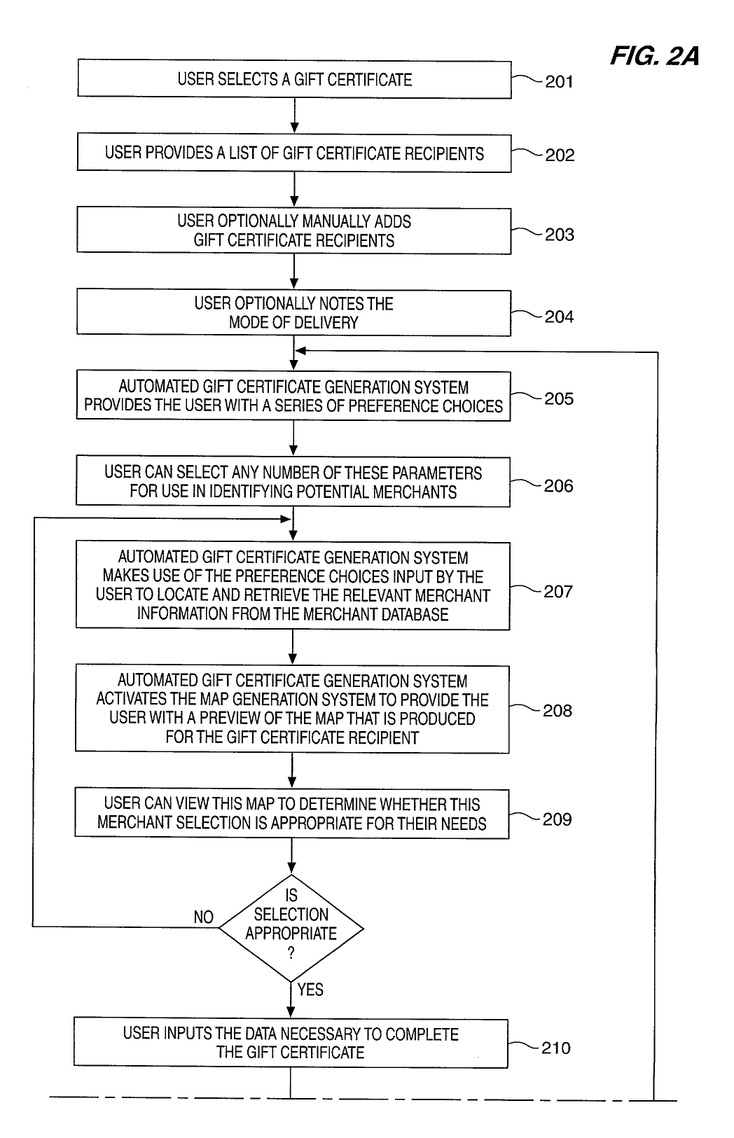

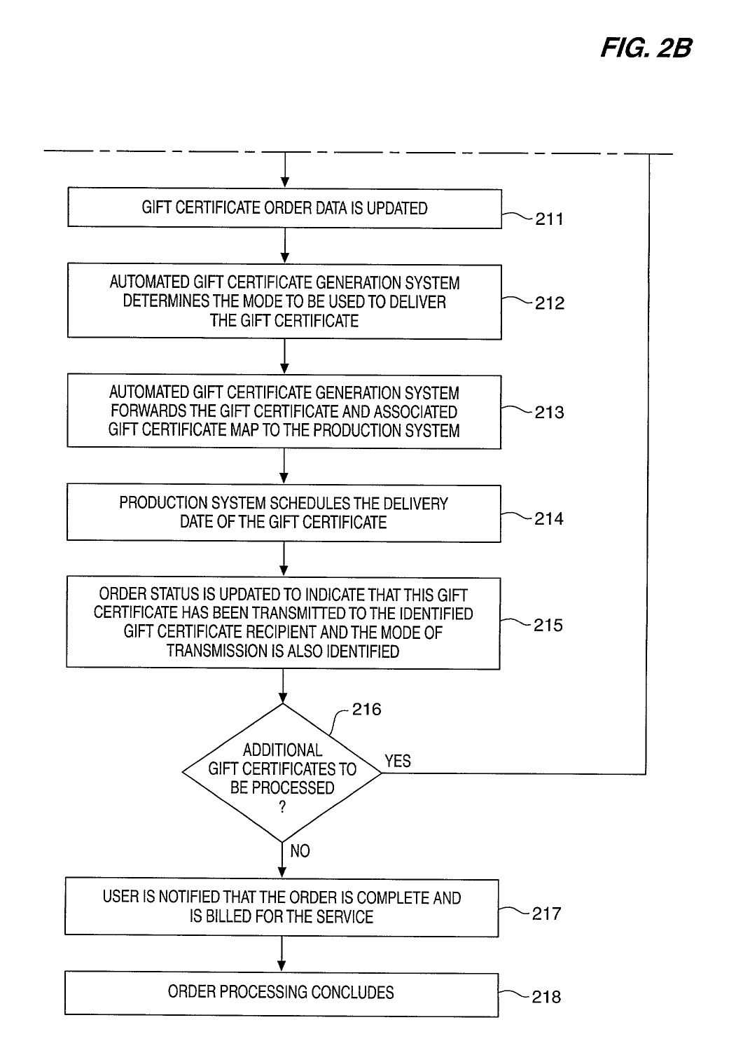

FIGS. 1A & 1B illustrate in block diagram form the overall architecture of the present automated gift certificate generation system and a typical environment in which it is operational and FIGS. 2A & 2B illustrate in flow diagram form the operation of the present automated gift certificate generation system. The architecture of the automated gift certificate generation system described herein represents a typical implementation of the automated gift certificate generation system and its operating environment and is not intended to limit the scope of the underlying concept as defined in the enclosed claims.

Customer Terminal Equipment and Communications Environment

The users are typically equipped with a personal computer T1, T2 hand held computing device, cellular communication device T3, T4, or other data interface device, collectively termed “terminal equipment” herein. The data communication connection between the user's terminal equipment T1 and the fulfillment center 120 can be via the Internet 103, using the well known personal computer modem and Internet browser technology available at the customer's terminal equipment T1. The user's terminal equipment is generally served by the Public Switched Telephone Network (PSTN) which consists of a plurality of Local Exchange System 101, 102 interconnected via an Inter-Exchange Carrier Network 100. The physical connection that supports this data communication connection is typically effected from user's terminal equipment T1 through the Local Exchange System 102 of the Public Switched Telephone Network (PSTN) to the Internet 103 (IP Network) via an Internet Service Provider 112 which is also connected thereto. The Internet 103 is also connected to a Local Exchange System 101 via Internet Service Provider 111 which serves the gateway 122 of the fulfillment center 120. Alternatively, the user's terminal equipment, in the case of cellular communication devices T3, T4, are connected via the Mobile Telecommunications Switching Office (MTSO) 104 to the Public Switched Telephone Network (PSTN).

Fulfillment Center

The fulfillment center 120 is connected to at least one data communication medium 103 (such as the Internet) to thereby enable users to obtain data communication connections with the fulfillment center 120, as described in more detail below. The resources illustrated herein are selected for the purpose of illustrating the concept of the fulfillment center 120 and are not intended to limit the applicability of this concept to other network implementations. Fulfillment center 120 consists of a server 121 which is connected to the Internet 103 via a gateway 122 that comprises the firewall which protects the fulfillment center 120 from unauthorized access and also implements the functionality to communicate with Internet Service Provider 111.

The fulfillment center 120 includes a plurality of databases which include: Order History, Users, Addresses, Gift Certificates, Merchants (123-126, 140), some of which can optionally or in part be resident on the user's terminal equipment, and production devices, such as a production system 128 which processes user orders and implements credit card billing while also including order production equipment to produce gift certificates. The fulfillment center 120 also includes a message system 122A that is used to generate and transmit e-mail messages to users and to also transmit any electronic gift certificates that are generated by the fulfillment center 120 to the designated gift certificate recipient. The map generation system 129 is shown as being an integral part of the fulfillment center 120, although the map generation system 129 can also be a stand alone system that is connected for example to the Internet (IP Network) 103 and accessible to the fulfillment center 120 via the Internet (IP Network) 103.

There are many configurations of the automated gift certificate map generation system 127 that can be envisioned, and the embodiment disclosed herein simply represents one of these configurations that illustrate the concepts of the invention. In particular, the description envisions the use of existing components in the fulfillment center 120 to implement the disclosed functionality. The automated gift certificate map generation system 127 includes, in whole or in part: the Addresses Database 125, map generation system 129, message system 122A, Gift Certificate Database 126, Merchant Database 140, production system 128 and the like, in implementing the automated gift certificate map generation functionality. For simplicity of description, the automated gift certificate generation system 127 is described herein and shown on FIG. 1B as a separate functionality, since in a typical fulfillment center implementation, the databases are shared among a number of processes. Therefore, the databases and other shared resources are illustrated as separate components although in some applications these components are an integral part of the automated gift certificate generation system 127.

User Orders Gift Certificates via the Internet

One example of a gift certificate purchase is where the user initiates their purchase order through the Internet to the fulfillment center 120 via a modem or other communication method. Assume for the purpose of this description that the user wishes the gift certificate to be sent directly to the gift certificate recipient and to have the fulfillment center 120 take care of the handling and postage or transmission by other means as defined by the user.

A user uses terminal equipment T2 in the well known manner described above to log into a selected Internet Web site, such as Hallmark.com, which executes on server 121, is part of the fulfillment center 120 and which provides the user with access to the automated gift certificate generation system 127. The server 121 connects the user to the automated gift certificate generation system 127 to execute a user login script which provides the user with a set of screens, transmitted seriatim and as a function of the users option selection, on the user's terminal device T2 to thereby enable the user to login by providing user identification and account information, in well-known fashion. The automated gift certificate generation system 127 as part of the login process confirms the identity of the user by comparing the user supplied data with data entries stored in Users Database 124 to confirm the user's identity and authority to access their address book entries (if any) stored in Addresses Database 125. Once the user's identity has been validated, the automated gift certificate generation system 127 retrieves the relevant customer data from Users Databases 124, & Addresses Database 125. The content of the retrieved data is typically directed by the screen entries provided by the user to indicate the function that the user wishes to execute. Thus, the user in the present example would indicate that the user plans to purchase a gift certificate and to have the gift certificate automatically addressed and sent to the event gift certificate recipient.

The automated gift certificate generation system 127 can include a shopping expert system functionality to guide the user through the gift certificate selection, gift certificate recipient list generation and gift certificate ordering steps. The automated gift certificate generation system 127 enables the user to initiate the gift certificate process by either generating the list of gift certificate recipients, or selecting and editing the gift certificate. The order of processing is optional and for the purpose of this description, the selection of the gift certificate is implemented prior to generating the list of gift certificate recipients and the provision of data used to populate the gift certificate.

Gift Certificate Selection

The automated gift certificate generation system 127 in well-known fashion at step 201 enables the user to select a gift certificate from the Gift Certificate Database 126, which is shown to be located in fulfillment center 120, but could be in an external location that can be accessed by the automated gift certificate generation system 127. The user identifies the desired gift certificate by means of a point and click operation that is well known in Internet product ordering, and the user's selection results in a gift certificate order being initiated by the automated gift certificate generation system 127. The gift certificate order initially includes the user's name and address, obtained from the login process described above, as well as an indication of the gift certificate that is selected at step 201. Alternatively, the selection of the gift certificate can be deferred until the user is ready to customize the gift certificate, once the merchant has been selected and the remaining gift certificate particulars have been determined. For the sake of this description, the gift certificate selection is noted as the first step in the process.

User Identifies Gift Certificate Recipient

At step 202, the user provides a list of gift certificate recipients to the automated gift certificate generation system 127. The list of gift certificate recipients can be at least one of: a subset of the user's addresses stored in Addresses Database 125 in the fulfillment center 120, an address list stored on the user's personal computer T2, an address book stored in a community address book, as described in U.S. patent application Ser. No. 09/502,728, titled “Reciprocal, Maintenance Free Community Membership Data Management System,” U.S. patent application Ser. No. 09/502,960, titled “Automatic Address Book Update System.” In addition, at step 203, the user can optionally manually add names and addresses of gift certificate recipients to the list. The user then optionally notes the mode of delivery of the gift certificate to each gift certificate recipient at step 204, if such information is not presently noted in the address entries. For example, one gift certificate recipient may preferentially desire a paper invitation, while another gift certificate recipient may desire an e-mail gift certificate, while a third gift certificate recipient may desire that the gift certificate be communicated to them via a cellular customer terminal device. The user can select the particular mode of transmission or can default to a generic mode of gift certificate delivery, such as mailing of a paper gift certificate.

Automated Merchant Identification and Selection

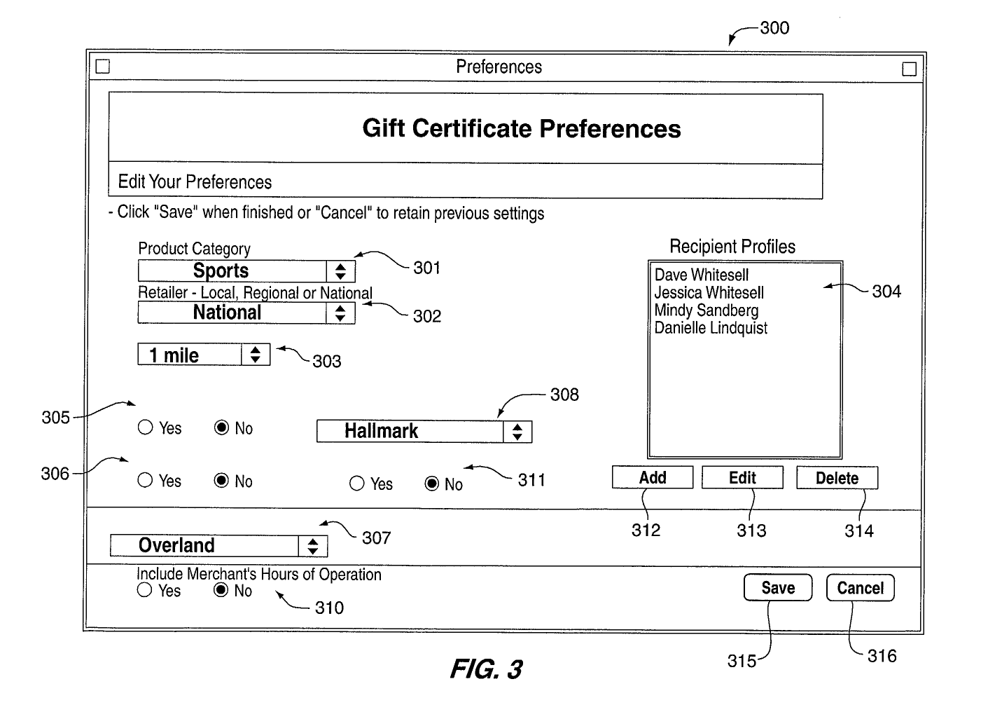

FIG. 3 illustrates the content of a typical option screen 300 presented to the user in the operation of the automated gift certificate generation system 127. The automated gift certificate generation system 127 at step 205 provides the user with a series of preference choices as displayed in FIG. 3. These preference choices enable the user to guide the automated gift certificate generation system 127 in identifying merchants that satisfy the parameters selected by the user. Some of the typical preference choices available to the user include, but are not limited to: distance to the merchant's store from the gift certificate recipient's address 303, type of merchant (national/regional chain, local) 302, products available at the merchant's store 301, gift certificate recipient profile 304, merchant location 307, merchant's name 308, and the like. The user can select any number of these parameters at step 206 for use in identifying potential merchants. These parameters are shown in FIG. 3 as scrollable lists, but the user can optionally be provided with the capability to enter their own data via data entry field 309. Thus, one selection on the scrollable list in this case can be “Other” which redirects the user choice to the data entry field 309 for a user defined data input.

Many of these preference choices are obvious in their meaning, but some of the user selections can optionally be used as data entry fields or data display fields in different combinations as noted above to obtain different results. For example, if the user selects the above-noted preference choices of distance 303 and merchant's name 308, this can result in several processing options as a function of the user's data entry. Thus, if the user inputs a numeric value in the data entry field 309 and associates this entry with the distance preference choice 303, the automated gift certificate generation system 127 can display merchant names 308 to indicate which merchants are located in the area delimited by the user's defined distance measurement. Alternatively, the user can designate a merchant name 308 in the data entry field 309 associated this data entry with the merchant name preference choice 308, and the automated gift certificate generation system 127 can display the distance 303 to the nearest store operated by this merchant.

The user can also identify a merchant location, such as a town, shopping mall, or other locale, that may not be located near the gift certificate recipient's address, but represents a shopping experience of convenience for the gift certificate recipient. For example, the gift certificate recipient may be planning a vacation at a resort or town having shopping opportunities of interest to the gift certificate recipient, and the user can select the resort or town as the preference choice, so the gift certificate recipient is provided with a gift certificate that can be redeemed at a merchant located at their travel destination. In this case, the base from which distance is calculated is the destination location, not the recipient's home location.

The user can also direct the automated gift certificate generation system 127 to access a profile listed in field 304, indicative of activities and/or shopping preferences, that is maintained for the gift certificate recipient in at least one of: the user's addresses stored in Addresses Database 125 in the fulfillment center 120, an address list stored on the user's personal computer T2, an address book stored in a community address book on another WEB site, and the like. The automated gift certificate generation system 127 uploads data that relates to the identified gift certificate recipient from the identified address book. These profiles can be edited via the use of the options buttons Add, 312, Edit 313, Delete 314 in well-known fashion. The Add 312 and Edit 313 buttons call up another data entry screen (not shown) that displays the data content for the selected recipient and/or enables the user to create a new profile. The automated gift certificate generation system 127 uses the gift certificate recipient profile data and/or a shopping expert to guide the user to select a type of product that the gift certificate recipient would be interested in as well as automatically identify the merchant(s) that offer such products. Thus, the preference options products available at the merchant's store, and gift certificate recipient profile can be used in an interactive manner to select a merchant.

It is obvious that the various combinations of preference options can be used by the user to refine the focus of the search for merchants or expand the focus of the search for merchants. The process of automated merchant selection is an interactive exchange between the automated gift certificate generation system 127 and the user providing preference options and specific selections. Once the user is satisfied with the results produced by the automated gift certificate generation system 127, the user can select a merchant at step 207 for use in generating the gift certificate.

Merchant Selection Process

The automated gift certificate generation system 127 makes use of the preference choices input by the user to locate and retrieve the relevant merchant information from the Merchant Database 140. In the simplest process, the automated gift certificate generation system 127 can use a basic search parameter, such as postal code to correlate the gift certificate recipient's address with merchants located in the vicinity. The vicinity can be defined as a radius from the address of the gift certificate recipient or a user specified geographic location. More precise coordinate-based location information (such as GPS data) could be used as an alternative. The Merchant Database 140 typically includes a set of data for each merchant, which set comprises a plurality of information typically including but not limited to: merchant's name, store address, telephone number, hours of operation, WEB site URL address, categories of products offered for sale by the merchant, name of nearest town or the name of the mall in which the store is located, and the like. The correlation of the user's preference options and the data contained in the Merchant Database 140 is accomplished in well-known database management processes, with the various user preference options optionally being assigned a weighting factor to more efficiently retrieve the merchant identification information from the Merchant Database 140. The user can also select what information from the Merchant Database 140 is included in the gift certificate via the use of preference options such as: view map 305, print map 306, and the like.

Map Generation

If the user selected the “view map” 305 preference option, the automated gift certificate generation system 127 activates the map generation system 129 at step 208 to provide the user with a preview of the map that is produced for the gift certificate recipient. This enables the user to confirm their merchant selection and to ensure that their choice was not based on misinterpreted data.

The automated gift certificate generation system 127 transmits a data file, or a pointer to a data file stored in address database 125 or external databases, to the map generation system 129 to indicate the need for a map. The map generation system 129, if needed, activates message system 122A to upload address information from externally located databases and uses the address data to generate an gift certificate map for the identified gift certificate recipients listed in the address book entry that has been retrieved. The map is generated by path definition module 129A of the map generation system 129 at step 208 in well-known manner to define the plurality of segments that comprise the path from the start to the end of the trip. The map generation system 129 also includes a map display module 129B which functions to output the generated map in the format and content required.

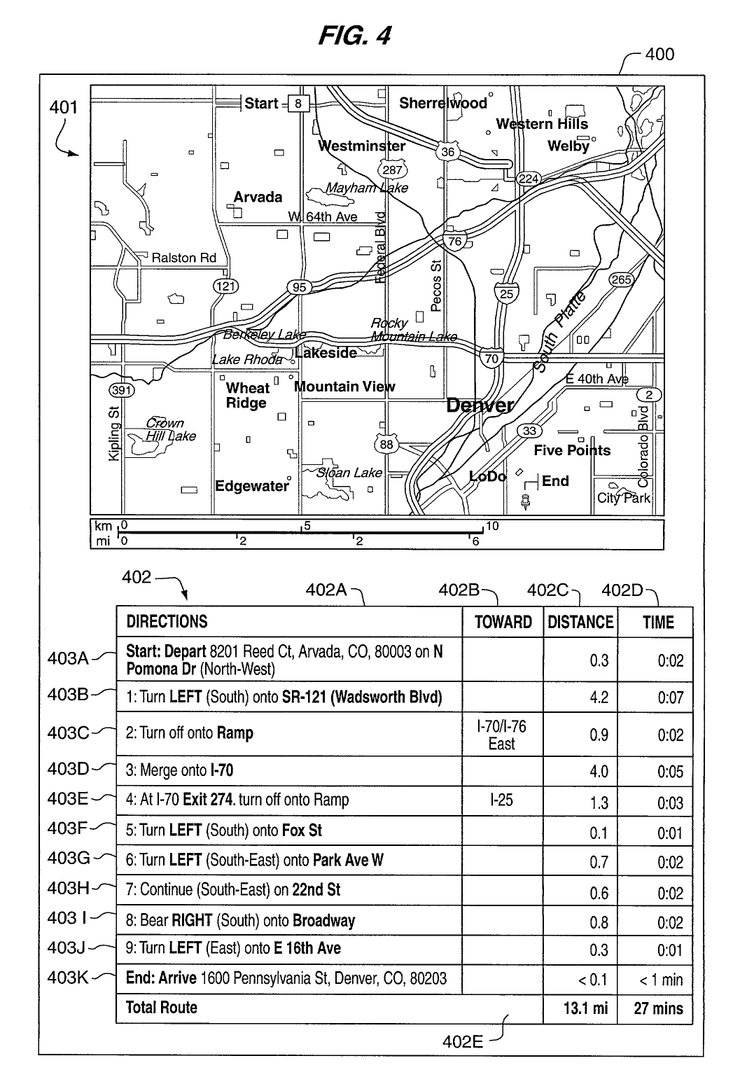

FIG. 4 illustrates a typical map 400 generated by the map generation system 129. The map 400 comprises an image of the map 401 and a description of the path 402. The description of the path 402 comprises a list 402A of a plurality of concatenated path segments 403A-403K, each of said plurality of concatenated path segments 403A-403K comprising a definition of a predetermined identified travel path. The travel path can include a distance traveled 402C on each of the path segments 403A-403K as well as an estimated travel time 402D to traverse each of the path segments 403A-403K. The estimated travel time can be an average time or can be selected to reflect the typical travel time for the time of day and day of the week of the event. The description of the path 402 can also include some travel specifics, such as the entry “Toward” which indicates additional direction information that helps orient the reader in interpreting the directions. Optionally, the map can include a drawing of the paths in typical map format to compliment the written description. The description of the path 402 also typically includes a summary line 402E where the total distance and time are noted.

In the example used in FIG. 4, a travel path is mapped from the home address of a gift certificate recipient “Arvada, Colo. ” to the location of the selected merchant's store “1600 Pennsylvania Avenue, Denver, Colo.”. As can be seen from FIG. 4, the route is divided into a plurality of segments 403A-403K to guide the gift certificate recipient via the simplest route to their destination. This path comprises 11 path segments, which follow the primary arterial roads in the area. Each of the plurality of path segments 403A-403K is described in words, distance and estimated travel time.

The user can view this map at step 209 to determine whether this merchant selection is appropriate for their needs, and if not, can return to the merchant selection at step 207 to revise their selection. Otherwise, the user can proceed to the final customization of the gift certificate and processing of their order.

Gift Certificate Customization

The user inputs the data necessary to complete the gift certificate at step 210. The gift certificate defines the gift certificate recipient, the monetary value of the gift certificate, the merchant(s) who will redeem the gift certificate, the occasion for which the gift certificate is issued, and optionally a personalized message from the user. Thus, the user populates the gift certificate with all of the information necessary to provide the gift certificate recipient with the data required to redeem the gift certificate. In addition, there is an analogous set of data generated in the case of an electronic version of the gift certificate being transmitted to a gift certificate recipient. The gift certificate order data is updated with this data at step 211 when the user selects the save 315 option.

Gift Certificate Production and Delivery

At step 212, the automated gift certificate generation system 127 determines the mode to be used to deliver the gift certificate and optional associated map to the gift certificate recipient by the use of another user screen display. The modes of delivery are well known and include: e-mail, mail, cellular call, voice message, text message. The determination can be defined by the user or determined from the data available to the automated gift certificate generation system 127 based upon the data provided by the user and/or obtained from records of prior transactions and/or user profiles of the gift certificate recipient retrieved from other sources.

In the case of a printed gift certificate, the map generation system 129 exports the generated maps to the automated gift certificate generation system 127 which then forwards the gift certificate and associated gift certificate map to the production system 128 to print the gift certificate with the gift certificate map either printed as an integral part of the gift certificate or as an enclosure therein at step 213. The production system 128 schedules the delivery date of gift certificate at step 214 and processes the gift certificate order by printing and mailing the gift certificates to the gift certificate recipients listed by the user. The order status is updated at step 215 to indicate that this gift certificate has been transmitted to the identified gift certificate recipient and the mode of transmission is also identified. At step 216 a determination is made whether additional gift certificates need to be processed in this order. If not, the user is notified at step 217 that the order is complete and they are billed for the service. The order processing then concludes at step 218. If additional gift certificates remain in the order to be processed, as determined at step 216, then processing advances to step 205 and another gift certificate recipient is selected from the list of gift certificate recipients and the gift certificate is processed in steps 206-216 as described above.

In the case of an electronic gift certificate, the automated gift certificate generation system 127exports the generated map and associated gift certificate to the gift certificate recipient listed by the user. The order status is updated at step 215 to indicate that this gift certificate has been transmitted to the identified gift certificate recipient and the mode of transmission is also identified. At step 216 a determination is made whether additional gift certificates need to be processed in this order. If not, the user is notified at step 217 that the order is complete and they are billed for the service. The order processing then concludes at step 218. If additional gift certificates remain in the order to be processed, as determined at step 216, then processing advances to step 205 and another gift certificate recipient is selected from the list of gift certificate recipients and the gift certificate is processed in steps 206-218 as described above.

User Orders Gift Certificates via a Retail Vendor or Kiosk

Alternatively, the user may shop at a retail establishment that uses point of sale terminals 133, connected to a server 131 and the Internet 103 via the gateway 132 and Local Exchange System 101. This equipment can be either located in a retail establishment as a customer service desk/customer kiosk, or can be embodied in a stand-alone kiosk at other than an in-store retail location. The point of sale terminal 133 can be used by a retail sales clerk to input gift certificate order data into server 131 to thereby enable the retail vendor to process the gift certificate purchase order and ship the gift certificate to the designated gift certificate recipient. The gift certificate order data includes the gift certificate data as noted above and uses the merchant data stored in Merchant Database 134. The retail vendor's server 131 is activated by the completion of a user's transaction to initiate a data transmission via: gateway 132, Local Exchange System 101, Internet Service Provider 111 and Internet 103 to the fulfillment center 120 via the Internet access path of fulfillment center 120 which comprises Internet Service Provider 111, local exchange system 101 and gateway 122, to access the fulfillment center 120 to optionally obtain part or all of the gift certificate recipient address data from the Addresses Database 124. The fulfillment center 120 then processes the received order as described above.

### SUMMARY

The automated gift certificate generation system enables the individual who is ordering gift certificates to simply download an address book of gift certificate recipients to the automated gift certificate generation system and the automated gift certificate generation system not only produces a customized gift certificate addressed to the gift certificate recipient, but also produces a map that provides the gift certificate recipient with directions to the merchant from the gift certificate recipient's home location.

What is claimed:

1. An automated gift certificate generation system for automatically identifying merchants to generate a gift certificate based on a location, comprising:
means for receiving gift certificate data that designates a plurality of gift certificate data including at least one of: geographic location, merchant identification, recipient profile, recipient address, monetary value of said gift certificate, product characteristics, mode of delivery, delivery date;
means for automatically identifying at least one merchant located in an area located proximate at least one of: said address of said gift certificate recipient and said geographic location;
means for enabling said user to select at least one of said identified merchants; and
means for generating a gift certificate that defines a monetary amount of said gift certificate and said selected merchant.

2. The automated gift certificate generation system of claim 1 wherein said means for receiving gift certificate data comprises:
means, responsive to establishment of a communication connection from a terminal device of said user to said automated gift certificate generation system, for transmitting a plurality of user data entry screens, seriatim to said terminal device to enable said user to input said gift certificate data.

3. The automated gift certificate generation system of claim 2 wherein said means for receiving gift certificate data further comprises:
means, responsive to receipt of gift certificate data indicative of a location of a recipient profile, for uploading said recipient profile from said location.

4. The automated gift certificate generation system of claim 2 wherein said means for enabling comprises:
means for receiving data from said user that defines a radius from said at least one of: said address of said gift certificate recipient and said geographic location as said area located proximate at least one of: said address of said gift certificate recipient and said geographic location.

5. The automated gift certificate generation system of claim 1 further comprising:
means for enabling said user to select a gift certificate from database of gift certificates.

6. The automated gift certificate generation system of claim 5 further comprising:
means for enabling said user to customize said selected gift certificate.

7. The automated gift certificate generation system of claim 1 further comprising:
means for enabling said user to select a mode of transmission used to transmit said selected gift certificate to said gift certificate recipient.

8. The automated gift certificate generation system of claim 1 wherein said means for receiving recipient data comprises:
means for downloading said data indicative of an address of said gift certificate recipient via a communication medium from an address book stored on a terminal device of said user.

9. The automated gift certificate generation system of claim 1 wherein said means for receiving recipient data comprises:
means for downloading said data indicative of an address of said gift certificate recipient via a communication medium from a web site address book.

10. The automated gift certificate generation system of claim 1 wherein said means for receiving recipient data comprises:
means for downloading said data indicative of an address of said gift certificate recipient via a communication medium from a data storage device located remote from said automated gift certificate generation system.

11. The automated gift certificate generation system of claim 1 further comprising:
means for generating a map that defines a travel path from said address of said gift certificate recipient to said merchant.

12. The automated gift certificate generation system of claim 11 wherein said means for generating a map comprises:
means for generating a list of a plurality of concatenated path segments, each of said plurality of concatenated path segments comprising a definition of a predetermined identified travel path.

13. The automated gift certificate generation system of claim 12 wherein said means for generating a map further comprises:
means for generating data indicative of a distance traveled along each of said plurality of concatenated path segments.

14. The automated gift certificate generation system of claim 13 wherein said means for generating a map further comprises:
means for generating data indicative of an estimate of a time required to travel along each of said plurality of concatenated path segments.

15. The automated gift certificate generation system of claim 13 wherein said means for generating a map further comprises:
means for generating a written description of said travel path describing each of said plurality of concatenated path segments and said distance traveled along each of said plurality of concatenated path segments.

16. The automated gift certificate generation system of claim 15 further comprising:
means for printing said written description on said gift certificate.

17. The automated gift certificate generation system of claim 15 further comprising:
means for printing said written description on a printed media for a one of: insertion into said gift certificate, and attached to said gift certificate.

18. The automated gift certificate generation system of claim 13 wherein said means for generating a map further comprises:
means for generating a display to illustrate said travel path comprising each of said plurality of concatenated path segments and said distance traveled along each of said plurality of concatenated path segments.

19. The automated gift certificate generation system of claim 18 wherein said gift certificate comprises an electronic format communication, said automated gift certificate generation system further comprises:
means for including said display with said gift certificate.

20. The automated gift certificate generation system of claim 1 wherein said means for automatically identifying comprises:
means for storing merchant information in a database; and
means for correlating said received gift certificate data with merchant information stored in said database to generate a list of said identified merchants.

21. The automated gift certificate generation system of claim 1 wherein said means for automatically identifying further comprises:
means for activating an automated shopping expert program to guide said user through a series of queries to generate data to supplement said received gift certificate data.

22. The automated gift certificate generation system of claim 1 wherein said means for generating a gift certificate comprises:
means for incorporating merchant store operating data comprising at least one of: business hours, telephone number, WEB site address, into said gift certificate.

23. A method of operating an automated gift certificate generation system for automatically identifying merchants to generate a gift certificate based on a location, comprising the steps of:
receiving gift certificate data that designates a plurality of gift certificate data including at least one of: geographic location, merchant identification, recipient profile, recipient address, monetary value of said gift certificate, product characteristics, mode of delivery, delivery date;
automatically identifying at least one merchant located in an area located proximate at least one of: said address of said gift certificate recipient and said geographic location;
enabling said user to select at least one of said identified merchants; and
generating a gift certificate that defines a monetary amount of said gift certificate and said selected merchant.

24. The method of operating an automated gift certificate generation system of claim 23 wherein said step of receiving gift certificate data comprises:
transmitting, in response to establishment of a communication connection from a terminal device of said user to said automated gift certificate generation system, a plurality of user data entry screens, seriatim to said terminal device to enable said user to input said gift certificate data.

25. The method of operating an automated gift certificate generation system of claim 24 wherein said step of receiving gift certificate data further comprises:
uploading, in response to receipt of gift certificate data indicative of a location of a recipient profile, said recipient profile from said location.

26. The method of operating an automated gift certificate generation system of claim 24 wherein said step of enabling comprises:
receiving data from said user that defines a radius from said at least one of: said address of said gift certificate recipient and said geographic location as said area located proximate at least one of: said address of said gift certificate recipient and said geographic location.

27. The method of operating an automated gift certificate generation system of claim 23 further comprising the step of:
enabling said user to select a gift certificate from database of gift certificates.

28. The method of operating an automated gift certificate generation system of claim 27 further comprising the step of:
enabling said user to customize said selected gift certificate.

29. The method of operating an automated gift certificate generation system of claim 23 further comprising the step of:
enabling said user to select a mode of transmission used to transmit said selected gift certificate to said gift certificate recipient.

30. The method of operating an automated gift certificate generation system of claim 23 wherein said step of receiving recipient data comprises:
downloading said data indicative of an address of said gift certificate recipient via a communication medium from an address book stored on a terminal device of said user.

31. The method of operating an automated gift certificate generation system of claim 23 wherein said step of receiving recipient data comprises:
downloading said data indicative of an address of said gift certificate recipient via a communication medium from a web site address book.

32. The method of operating an automated gift certificate generation system of claim 23 wherein said step of receiving recipient data comprises:
downloading said data indicative of an address of said gift certificate recipient via a communication medium from a data storage device located remote from said automated gift certificate generation system.

33. The method of operating an automated gift certificate generation system of claim 23 further comprising the step of:
generating a map that defines a travel path from said address of said gift certificate recipient to said merchant.

34. The method of operating an automated gift certificate generation system of claim 33 wherein said step of generating a map comprises:
generating a list of a plurality of concatenated path segments, each of said plurality of concatenated path segments comprising a definition of a predetermined identified travel path.

35. The method of operating an automated gift certificate generation system of claim 34 wherein said step of generating a map further comprises:
generating data indicative of a distance traveled along each of said plurality of concatenated path segments.

36. The method of operating an automated gift certificate generation system of claim 35 wherein said step of generating a map further comprises:
generating data indicative of an estimate of a time required to travel along each of said plurality of concatenated path segments.

37. The method of operating an automated gift certificate generation system of claim 35 wherein said step of generating a map further comprises:
generating a written description of said travel path describing each of said plurality of concatenated path segments and said distance traveled along each of said plurality of concatenated path segments.

38. The method of operating an automated gift certificate generation system of claim 37 further comprising the step of:
printing said written description on said gift certificate.

39. The method of operating an automated gift certificate generation system of claim 37 further comprising the step of:
printing said written description on a printed media for a one of: insertion into said gift certificate, and attached to said gift certificate.

40. The method of operating an automated gift certificate generation system of claim 35 wherein said step of generating a map further comprises:
generating a display to illustrate said travel path comprising each of said plurality of concatenated path segments and said distance traveled along each of said plurality of concatenated path segments.

41. The method of operating an automated gift certificate generation system of claim 40 wherein said gift certificate comprises an electronic format communication, said method of operating an automated gift certificate generation system further comprises the step of:
including said display with said gift certificate.

42. The method of operating an automated gift certificate generation system of claim 23 wherein said step of automatically identifying comprises:
storing merchant information in a database; and
correlating said received gift certificate data with merchant information stored in said database to generate a list of said identified merchants.

43. The method of operating an automated gift certificate generation system of claim 23 said step of automatically identifying further comprises:
activating an automated shopping expert program to guide said user through a series of queries to generate data to supplement said received gift certificate data.

44. The method of operating an automated gift certificate generation system of claim 23 wherein said step of generating a gift certificate comprises:
incorporating merchant store operating data comprising at least one of: business hours, telephone number, WEB site address, into said gift certificate.
